(19) United States
(12) Patent Application Publication
(10) Pub. No.: US 2025/0023741 A1
(43) Pub. Date: Jan. 16, 2025

(54) AUTHENTICATING VIDEO DATA UTILIZING A CONTEXTUAL IDENTIFIER

(71) Applicant: International Business Machines Corporation, Armonk, NY (US)

(72) Inventors: Shikhar Kwatra, San Jose, CA (US); Tiberiu Suto, Franklin, NY (US); Hemant Kumar Sivaswamy, Pune (IN); Dinesh Kumar Bhudavaram, Bangalore (IN); Nadiya Kochura, Bolton, MA (US)

(21) Appl. No.: 18/352,297

(22) Filed: Jul. 14, 2023

(51) Int. Cl. H04L 9/32; H04L 9/08

(52) U.S. Cl. CPC H04L 9/3247; H04L 9/0866

(57) ABSTRACT

Embodiments of the present invention provide an approach for authenticating video data utilizing a contextual identifier. Specifically, a set of video data including contextual identifiers is captured. A respective cryptographic signature for each frame of the set of video data is generated utilizing metadata of the respective frame. Each frame of the set of video data and the respective cryptographic signature are stored on a blockchain, and the set of video data is authenticated utilizing the respective cryptographic signatures stored on the blockchain.

### TECHNICAL FIELD

The present invention relates generally to authenticating video data, and more specifically to embodiments for video data authentication utilizing one or more contextual identifiers.

### BACKGROUND

The use of photographs and moving pictures (now more commonly called images and video, respectively) in documentation has been offered as evidence or other proof of events and provenance practically since the invention of the camera. Unsurprisingly, techniques for visual media manipulation closely followed. While this visual media manipulation proved an exciting field for early photography and moving picture pioneers, such alteration continues to present new challenges to visual special effects artists to this day. Accordingly, consumers of visual media have long been forced to question whether the visual media they are viewing is truly authentic, or even when and where it is purported to originate. In some instances, a cameraperson might include a newspaper bearing a date or live television broadcast in a shot to be used as a possible way to timestamp a video or other type of visual media. As visual media advanced from analog film to a digital format, metadata tags indicating a time when, and a location where the visual media was originally captured began to annotate digital visual media files. In the case of video, these metadata tags may be part of a video file container, which also contains visual data (e.g., video frames) in a video coding format, audio data in an audio coding format, as well as synchronization information, subtitles, and other metadata such as a video title. Examples of popular digital video formats include, but are not limited to, Audio Video Interleave (AVI), Advanced Video Coding High Definition (AVCHD), Flash video formats FLV, F4V, and Shockwave Flash (SWF), HTML5, QuickTime Movie (MOV), MPEG-4 Part 14 (MP4), MPEG-2, WebM, and Windows Media Viewer (WMV). It should be understood that the word “video” as used herein is intended to convey a digital video file in any digital video file format.

### SUMMARY

Embodiments of the present invention provide an approach for authenticating video data utilizing a contextual identifier. Specifically, a set of video data including contextual identifiers is captured. A respective cryptographic signature for each frame of the set of video data is generated utilizing metadata of the respective frame. Each frame of the set of video data and the respective cryptographic signature are stored on a blockchain, and the set of video data is authenticated utilizing the respective cryptographic signatures stored on the blockchain.

A first aspect of the present invention provides a method for authenticating video data utilizing a contextual identifier, comprising: capturing, by a processor, a set of video data comprising one or more contextual identifiers; generating, by a processor, a respective cryptographic signature for each frame of the set of video data, wherein the respective cryptographic signature is generated utilizing metadata of the respective frame; storing, by a processor, each frame of the set of video data and the respective cryptographic signature on a blockchain; and authenticating, by a processor, the set of video data utilizing one or more of the respective cryptographic signatures stored on the blockchain.

A second aspect of the present invention provides a computing system for authenticating video data utilizing a contextual identifier, comprising: a processor; a memory device coupled to the processor; and a computer readable storage device coupled to the processor, wherein the storage device contains program code executable by the processor via the memory device to implement a method, the method comprising: capturing, by the processor, a set of video data comprising one or more contextual identifiers; generating, by the processor, a respective cryptographic signature for each frame of the set of video data, wherein the respective cryptographic signature is generated utilizing metadata of the respective frame; storing, by the processor, each frame of the set of video data and the respective cryptographic signature on a blockchain; and authenticating, by the processor, the set of video data utilizing one or more of the respective cryptographic signatures stored on the blockchain.

A third aspect of the present invention provides a computer program product for authenticating video data utilizing a contextual identifier, the computer program product comprising a computer readable storage device, and program instructions stored on the computer readable storage device, to: capture a set of video data comprising one or more contextual identifiers; generate a respective cryptographic signature for each frame of the set of video data, wherein the respective cryptographic signature is generated utilizing metadata of the respective frame; store each frame of the set of video data and the respective cryptographic signature on a blockchain; and authenticate the set of video data utilizing one or more of the respective cryptographic signatures stored on the blockchain.

Still yet, any of the components of the present invention could be deployed, managed, serviced, etc., by a service provider who offers to provide an approach for authenticating video data utilizing a contextual identifier in a computer system.

Embodiments of the present invention also provide related systems, methods, and/or program products.

### BRIEF DESCRIPTION OF THE DRAWINGS

FIG. 1 depicts a block diagram illustrating an example of an environment for the execution of at least some of the computer code involved in performing the inventive methods, in accordance with embodiments of the present invention.

FIG. 2 depicts a block diagram of a distributed system involved in performing the inventive methods, in accordance with embodiments of the present invention.

FIG. 3 depicts an example implementation, in accordance with embodiments of the present invention.

FIG. 4 depicts a further example implementation, in accordance with embodiments of the present invention.

FIG. 5 depicts a flow diagram related to authenticating video data utilizing a contextual identifier, in accordance with an embodiment of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity

### DETAILED DESCRIPTION

Videos can be an invaluable, but unreliable piece of evidence. While people may rely on a video to prove the condition of an apartment at move-in and move-out, or to demonstrate that they truly were at a particular location when claimed, or even that the video itself is their work and not somebody else's, verifying these claims can be particularly challenging in today's world. Metadata tags in a video file container indicating when and where the video was originally taken can easily be swapped for erroneous data. Moreover, image and video manipulation technology can alter what is seen in a frame essentially seamlessly. This means that even apparently corroborating date indicators displayed on real-world objects (e.g., newspapers, live television programs, calendars, clocks, product expiration dates) within the video, can be repurposed as an intentionally deceptive feature of the video. Moreover, recent advances in artificial intelligence (AI) and similar services make alterations feasible even for someone who has little or no skill in using video editing software. When even individual frames of a video may be deceptively altered, it is desirable to be able to validate that each and every frame is a genuine part of the original video and unedited in any manner.

Accordingly, embodiments of the present invention enable individual frames of a video to be authenticated as part of a blockchain against other frames in the video based on contextual date identifiers contained within the content of that video. This is achieved by generating a cryptographic signature for each frame in the video using a date proving feature of the video frame. According to embodiments, the context-dependent cryptographic signature of each frame in the video is sequentially used as the basis for a blockchain, such that each subsequent block or frame is dependent on the last. Therefore, if any block/frame containing a contextual date indicator is removed, altered, or replaced, the resulting discontinuity with the blockchain would make this tampering evident.

This offers several advantages in the art, including, but not limited to, permitting video files to be self-authenticating. Moreover, videos that have such extensive proof of validity can be confidently submitted as a proof in instances where video evidence is required to resolve a dispute or other matter. Embodiments of the present invention further allow a video to be given more weight or value due to its proof of genuineness. Furthermore, in addition to providing proof of authenticity, embodiments of the present invention can be used to provide proof of ownership of a video, thereby making it substantially more difficult for others to pass off video content that is not their own.

Disclosed embodiments provide techniques for authenticating video data utilizing a contextual identifier. Specifically, a set of video data including contextual identifiers is captured. A respective cryptographic signature for each frame of the set of video data is generated utilizing metadata of the respective frame. Each frame of the set of video data and the respective cryptographic signature are stored on a blockchain, and the set of video data is authenticated utilizing the respective cryptographic signatures stored on the blockchain.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

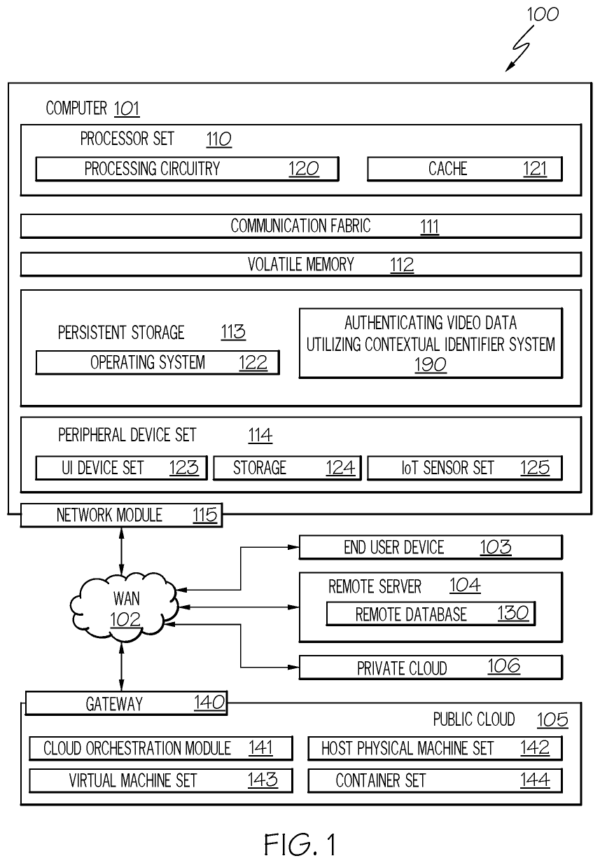

FIG. 1 shows an exemplary computing environment 100 in accordance with disclosed embodiments. Computing environment 100 contains an example of an environment for the execution of at least some of the computer code involved in performing the inventive methods, such as authenticating video data utilizing contextual identifier system 190 (hereinafter system 190). In addition to system 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 190, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in system 190 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in system 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

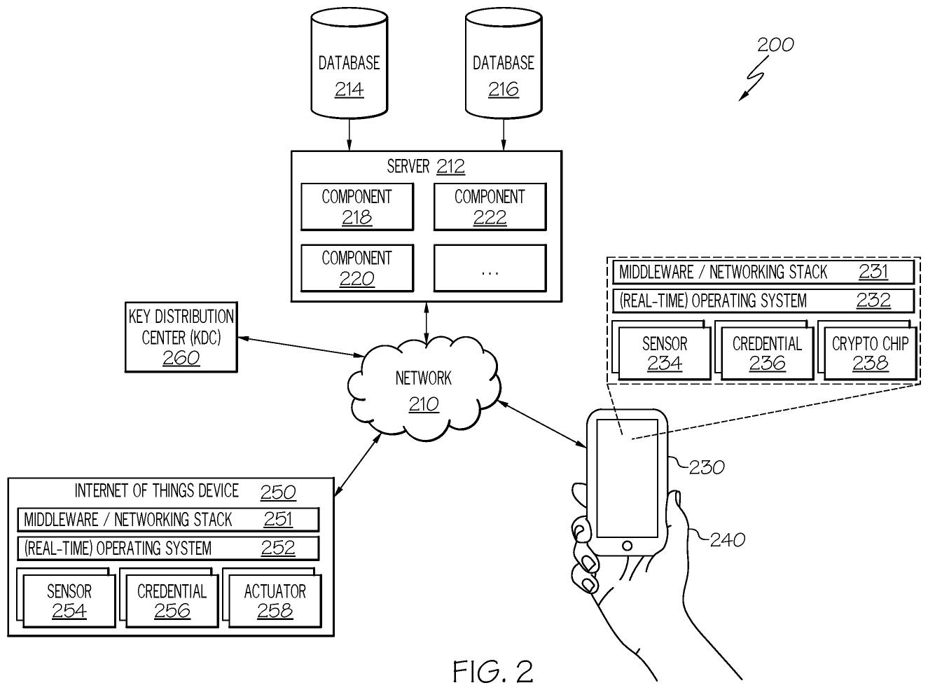

FIG. 2 depicts a block diagram of a distributed system 200 for implementing one or more of the embodiments. In the illustrated embodiment, distributed system 200 includes one or more client video recording devices 230, which are configured to execute and operate a client application such as a video recording application, a web browser, a proprietary client, or the like over one or more network(s) 210. In some embodiments, distributed system 200 can further include one or more Internet of Things (IoT) devices 250 in contact with one or more network(s) 210. In further embodiments, distributed system 200 can include a Key Distribution Center (KDC) 260 that provides keys through one or more network(s) 210. Server 212 may be communicatively coupled with client video recording devices 230 of user 240, IoT devices 250, and KDC 260.

Distributed system 200 shown in FIG. 2 depicts a detailed implementation example of one embodiment of system 190 that is shown in FIG. 1. Other implementations of system 190 which differ from distributed system 200 are possible, as may be described in alternative embodiments.

In one embodiment, client video recording devices 230 may comprise middleware/networking stack 231 which comprises software to communicate with other network-connected devices on one or more network(s) 210. Real Time Operating System 232 comprises software that may provide services for recording devices 230 that are typically associated with an operating system such as invoking software modules, routines, and functions in response to device inputs and interrupts initiated by user 240. Sensor 234 may comprise a digital imaging sensor such as, for example, a charge-coupled device (CCD) or an active-pixel sensor CMOS sensor, that may be used to capture image data as a sequence of video frames. Credential 236 may comprise user identity, authorization, and authentication credentials, as well as public and private encryption keys which may be utilized by cryptography chip 238. The encryption keys may be utilized by cryptography chip 238 to encrypt image data captured as a sequence of video frames by sensor 234.

According to some embodiments, client video recording device 230 can be a network-connected smart camera with unique serial number used to capture a set of video data. The smart the camera can have access to a cloud enabled service that provides a certified date cryptographic signature. For instance, when or immediately after a video has been recorded on the camera, the camera would send a request to the service with the camera's serial number, a unique video identification number, and optionally GPS location, to provide a certified date for embedding in the video.

Internet of Things (IoT) devices 250 may comprise middleware/networking stack 251 which comprises software to communicate with other network-connected devices on one or more network(s) 210. Real Time Operating System 252 comprises software that may provide services for IoT devices 250 that are typically associated with an operating system such as invoking software modules, routines, and functions in response to device inputs and interrupts. Sensor 254 may comprise a digital imaging sensor such as, for example, a charge-coupled device (CCD) or an active-pixel sensor CMOS sensor, that may be used to capture image data. In one embodiment, IoT devices 250 may comprise an Internet of Things (IoT) network-connected appliance, such as a refrigerator or other storage device, and sensor 254 may be utilized to capture image data related to items stored therein, including product labels, descriptions, and names, Universal Product Code (UPC) barcodes, and product expiration dates.

Credential 256 may comprise user identity, authorization, and authentication credentials to validate requests received by IoT devices 250 over network(s) 210. In one embodiment, actuator 258 may perform actions indicated by requests received by IoT devices 250 over network(s) 210. For example, in one embodiment, IoT devices 250 may comprise a network-connected smart television, and an action performed by actuator 258 may comprise turning the television power to “on,” and having the tuner on the television receive and display a specific channel being transmitted from a television station. In another embodiment, IoT devices 250 may comprise a network-connected computing device and an action performed by actuator 258 may comprise turning the computing device power to “on,” and having the computing device display a specified screen, application, or a particular data item. For example, actuator 258 may cause the computing device to display data contained in the memory of the computing device or obtained over network(s) 210, such as today's date, time, or a webpage containing a news item or event that occurred on a particular day.

In one embodiment, key distribution center (KDC) 260 provides encryption keys to allow secure transmission of sensitive or private data between devices that exchange data over network(s) 210. When a network connection is established between, for example, recording devices 230 and IoT devices 250 over network(s) 210, both devices 230 and 250 request that KDC 260 generate a unique key that can be used for secure encrypted data transmission between devices 230 and 250. Various methods of encryption using public and private encryption keys are known, and further description is not believed necessary.

In various embodiments, server 212 may be adapted to run one or more services or software applications provided by one or more of the components 218, 220, 222 of the system. In some embodiments, these services may be offered as web-based or cloud services or under a Software as a Service (SaaS) model to a user 240 of one or more client video recording devices 230. User 240 operating client video recording device 230 may in turn utilize one or more client applications to interact with server 212 to utilize the services provided by these components.

In the configuration depicted in FIG. 2, the software components 218, 220, and 222 of system 200 are shown as being implemented on server 212. User 240 operating the client video recording devices 230 may then utilize one or more client applications to use the services provided by these components 218, 220, and 222. These components 218, 220, and 222 may be implemented in hardware, firmware, software, or combinations thereof. It should be appreciated that various different system configurations are possible, which may be different from distributed system 200. The embodiment shown in the figure is thus one example of a distributed system for implementing an embodiment system and is not intended to be limiting. Although exemplary distributed system 200 is shown with one client video recording device 230, any number of client video recording devices may be supported.

Network(s) 210 in distributed system 200 may be any type of network familiar to those skilled in the art that can support data communications using any of a variety of commercially available protocols, including without limitation TCP/IP (transmission control protocol/Internet protocol), SNA (systems network architecture), IPX (Internet packet exchange), AppleTalk, and the like. For example, network(s) 210 can be a local area network (LAN), such as one based on Ethernet, Token-Ring and/or the like. Network(s) 210 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 212 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 212 may be adapted to run one or more services or software applications described in the foregoing disclosure. For example, server 212 may correspond to a server for performing processing described herein according to an embodiment of the present disclosure.

In some implementations, server 212 may include one or more applications to analyze and consolidate data feeds and/or event updates received from client video recording device 230 and/or IoT device 250. As an example, data feeds and/or event updates may include, but are not limited to, real-time updates received from one or more third party information sources and continuous data streams, which may include real-time events related to sensor data applications, network performance measuring tools (e.g., network monitoring and traffic management applications), clickstream analysis tools, and the like. Server 212 may also include one or more applications to display the data feeds and/or real-time events via one or more display devices of client video recording device 230.

Distributed system 200 may also include one or more databases 214 and 216. Databases 214 and 216 may reside in a variety of locations. In an example, one or more of databases 214 and 216 may reside on a storage medium local to (and/or resident in) server 212. Alternatively, databases 214 and 216 may be remote from server 212 and in communication with server 212 via a network-based or dedicated connection. In one set of embodiments, databases 214 and 216 may reside in a storage-area network (SAN). Similarly, any necessary files for performing the functions attributed to server 212 may be stored locally on server 212 and/or remotely, as appropriate. In one set of embodiments, databases 214 and 216 may include relational databases that are adapted to store, update, and retrieve data in response to computing language commands.

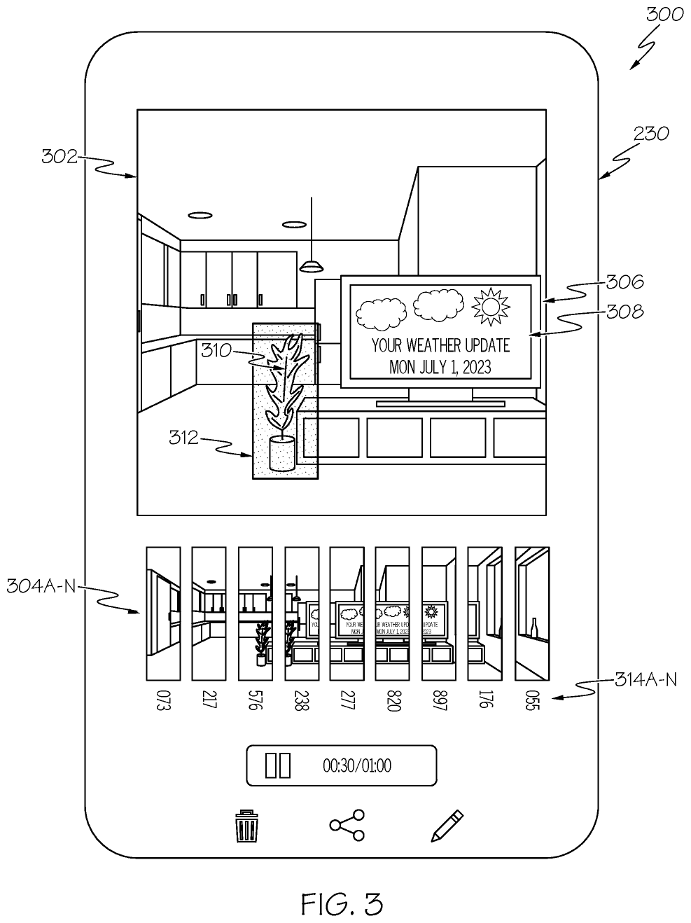

Referring now to FIG. 3, in connection with FIG. 1 and FIG. 2, an example implementation 300 according to embodiments of the present invention is shown. Although this example makes reference to an apartment walk-though video, it should be understood that applications of embodiments of the present invention are not limited to such. More specifically, implementation 300 shows a playback of video 302, which has been recorded using client video recording device 230. Video 302 comprises a plurality of frames 304A-N(herein each individually, frame 304N). Techniques for authenticating video data of video 302 utilizing a contextual identifier in video 302 will now be discussed.

System 190 (shown in FIG. 1) can capture, using client video recording device 230, a set of video data comprising one or more contextual identifiers. The captured video data includes, but is not limited to, frames 304A-N of video 302, as well as metadata obtained during the video recording, such as a Global Positioning System (GPS) reading from a sensor of client video recording device 230 and a timestamp from an internal clock or externally controlled clock of client video recording device 230. The captured video data can further include, but is not limited to, third-party metadata obtained through network 210 from, for example, IoT device 250, KDC 260, and/or server 212.

One or more frames 304A-N of video 302 can contain an image of a real-world object, such as television 306 or another IoT-enabled smart device or other contextual identifier 310 (e.g., a season-sensitive houseplant). System 190 can perform object recognition analysis on one or more objects in the field of view of camera sensor 234 during or after recording of the video. According to some embodiments of the present invention, system 190 can use a machine learning model for computer vision object detection, such as a Region-based Convolutional Neural Network (R-CNN), to identify the objects. Objects that are identified as capable of being used to indicate a date, time, or even approximate date of the recording of the video can be further scanned not merely for identification, but for dates (e.g., a date on a newspaper or utility bill) or other status indicators (e.g., weather typical of a particular season on a live news broadcast; presence of objects that are only seen during a particular time of year, such as ripe pumpkins in autumn).

More specifically, system 190 can identify one or more contextual identifiers 310 in the set of video data. To accomplish this, once one or more objects that are potential contextual identifiers 310 are identified, and the object can be further scanned to obtain a current date context. These contextual identifier 310 function to tie the video content taken with a time (e.g., read from a clock object in a viewing area), a date (e.g., inferred or approximated from an expiration date on packaging for a perishable food object in the viewing area), an era (e.g., approximated based on a current status of an object in the viewing area that has different behaviors depending on season, year, etc.), etc. of the original recording. According to some embodiments, systems 190, through client video recording device 230 (shown in FIG. 2), can isolate individual potential contextual identifiers 310 using a bounding box or similar techniques. Bounding box 312 is a typically a rectangular collision box generated as a virtual object that serves as a point of reference for real-world object detection in a video environment. Bounding box 312 can be drawn over potential contextual identifiers 310 to outline these real-world objects by defining their X and Y coordinates, thereby isolating a specific area for further analysis and context identifier retrieval.

In some embodiments, system 190 can activate the one or more contextual identifiers 130 (shown in FIG. 1) using an Internet Protocol (IP) network. Examples of such IP network activated contextual identifiers 130 include, but are not limited to, an IoT network-connected appliance, a network-connected smart television, and a network-connected computing device. An IoT network-connected appliance can be any IoT device 250 (shown in FIG. 2) connected to network 210 (shown in FIG. 2) and capable of producing data that can be used as a time reference. For example, a smart thermostat could provide a current building thermostat reading or thermostat setting. An air-conditioning setting being active is more likely to correlate with a summer month, whereas a heating setting is more likely to correlate with a winter month. In another example, a smart refrigerator may be equipped with a set of sensors capable of registering the items stored therein, as well as reading (e.g., by a text reader or a barcode reader which may be able to determine a date of manufacture from the barcode) and logging their expiration dates for the purpose of warning a user when food is about to expire. A carton of milk may bear a particular expiration date, which can generally be an indicator that the current date is most likely within two weeks of that expiration date. Such indicators of date can be requested from IoT device 250 by client video recording device 230 over network 210, using IP network protocols, for the purpose of integrating a contextual date into video 302.

Alternatively, or additionally, a network-connected smart television (e.g., television 306) can act as contextual identifier 310. Client video recording device 230 can send a request, over network 210, using IP network protocols, to television 306, which has been identified as a potential context identifier 310 in the video shot, to turn on (if not already on) and switch to a channel that provides a live broadcast or otherwise current television program 308 (e.g., a news broadcast, even if recorded earlier in the day), such as a current weather broadcast. As news and weather broadcasts typically make reference to a current date or even time (e.g., the 6 o'clock news), these provide a convenient date context.

Moreover, other network-connected computing devices, alternatively or additionally, can act as a contextual identifier 310. Client video recording device 230 can send a request for a date or timestamp context, over network 210, using IP network protocols, to a networked computing device, such as a laptop. The computing device may send back content such as, but not limited to, a most recent email received by the computing device, a next appointment listed in a calendar of the computing device, etc.

In any case, system 190 can determine a date stamp utilizing one or more contextual identifiers 130. According to embodiments, this can be accomplished by Optical Character Recognition (OCR) scanning an image of a contextual identifier 130 bearing date information (e.g., a food expiration date, a newspaper or bill date, a calendar, a date/time on a current television program 308). An object recognition analysis component of system 190 can use a determined identity of contextual identifier 130 to gauge a date range most likely associated with such an identified object bearing a date. For example, if contextual identifier 130 is a perishable food item, the shelf life of that food item can be used to predict an earliest and latest date that the present date likely is based on the existence of this food item. For instance, a loaf of bread having a barcode indicating it was baked on a particular date could be analyzed to determine that the current date is likely no more than a week after that baked-on date (and no less than the baked-on date).

Even if an OCR or similar scan is not utilized for a potential contextual identifier 130, the object recognition analysis component of system 190 can use a determined identity of contextual identifier 130 to gauge a likely current date. For example, if the object recognition analysis component of system 190 identifies contextual identifier 130 to be a holiday decoration, system 190 can determine that the current date is most likely a date within the month that the holiday takes place. Moreover, some items may have a difference appearance based on a time of year. For instance, the plant shown in FIG. 3 as an example of contextual identifier 130 could be a plant that loses its foliage for a portion of the year or that only blooms during a particular time of year. Identifying the plant and its current status would allow system 190 to determine that the current date is during or at least substantially during the period where the plant typically looks the way that the plant appears to look.

System 190 can generate a respective cryptographic signature 314A-N (individually 314N) for each frame 304A-N of the set of video data, wherein the respective cryptographic signature 314N is generated utilizing metadata of the respective frame 304N. The metadata of frame 304N used to generate a respective cryptographic signature 314N can include, but is not limited to, a check-sum of frame 304N, a date stamp (or approximate date) of contextual identifier 310 (determined using techniques such as those discussed above), and GPS data (e.g., from a GPS sensor of client video recording device 230). Each frame 304N is signed with its cryptographic signature 314N. It should be noted that the numbers shown as cryptographic signatures 314A-N in FIG. 3 are intended for simplified demonstration purposes only and are not intended to limit any manner in which a cryptographic signature may be expressed.

For frames which contain contextual identifier 310, system 190 can tokenize one or more features of contextual identifier 310 for integration into cryptographic signature 314N. Tokenized features can include the derived date, time, or approximate date itself, as well as information characterizing an appearance or status of contextual identifier 310 (e.g., color, size within frame, or other features identified by object recognition analysis component of system 190). In any case, a frame 304N which contains a contextual identifier 310 will have a respective cryptographic signature 314N that reflects a specific feature of contextual identifier 310.

In some embodiments, system 190 can generate a respective cryptographic signature 314N for each frame 304N of the set of video data utilizing a cryptography integrated circuit operating in a secure enclave. According to some embodiments, this cryptography integrated circuit can be cryptography chip 238 (shown in FIG. 2) of client video recording device 230. In still other embodiments, the cryptography integrated circuit can be separate from client video recording device 230, residing, for example on an IoT device 250 or being part of an infrastructure of server 212 (shown in FIG. 2). In still other embodiments, system 190 can generate cryptographic signature 314N for each frame 304N of the set of video data utilizing a cryptography software running on a machine or virtual machine in network 210.

Furthermore, in some embodiments, client video recording device 230 can have a unique serial number and/or be linked to a cloud enabled cryptographic service. In such a case, the metadata of one or more frames 304A-N can comprise the unique serial number of the camera/client video recording device 230. As such, the serial number of client video recording device 230 or a service-provided cryptographic key therewith associated can be an input used in the generation of cryptographic signatures 314A-N. Moreover, in some embodiments, client video recording device 230 could send a video identification and a video checksum to the cloud enabled cryptographic service to be used as a future means of verifying that the video has not been truncated (as the blockchain encryption methods discussed below can best be used to verify that no frame or frames have been altered, but may struggle to determine how many frame blocks there should be in a total chain).

System 190 can store (e.g., in database 214 or 216 shown in FIG. 2) each frame 304A-N of the set of video data and the respective cryptographic signature 314A-N on a blockchain in a sequential order. A blockchain is a ledger distributed across multiple computers, which can be located in separate locations and run by anyone with an Internet connection. At its core, a blockchain is a ledger through which data is added and updated in real-time via consensus of the different software clients/nodes running the software in the network. However, once the data is added to the ledger, it cannot be removed or edited, thereby providing a protocol architecture that removes the need to trust in a permissionless network. In a blockchain network, storage and data are redundant, meaning that as long as nodes are running, there is no central point of failure. More specifically, each block is dependent on the previous block. In embodiments of the present invention, each sequential block corresponds with a sequential cryptographic signature signed frame of video 302. Therefore, a ledger is created which memorializes a sequence and signatures of frames video 302. As each frame's block is dependent on the prior frame's block, a comparison of the resulting ledger against a video purporting to be the same video as video 302 will reveal if any one or more frames have been removed or subject to tampering. In some additional or alternative embodiments, only each frame 304A-N of the set of video data will be stored on the blockchain in a sequential order. In still other additional or alternative embodiments, only each respective cryptographic signature 314A-N will be stored on the blockchain in a sequential order.

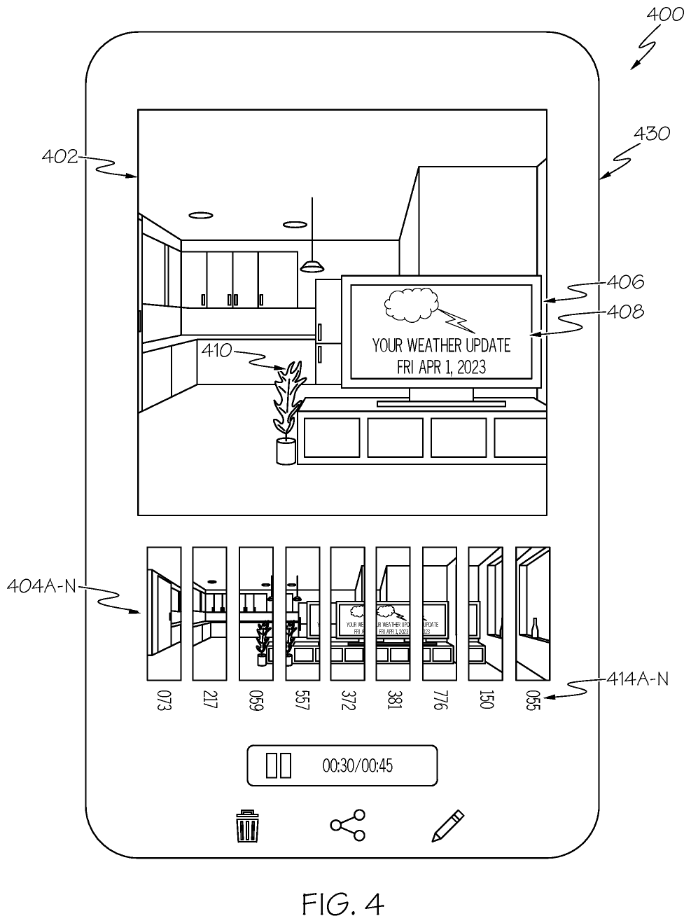

Referring now to FIG. 4, in connection with FIG. 3, a further example implementation 400 according to embodiments of the present invention is shown. System 190 (shown in FIG. 1) can authenticate the set of video data utilizing one or more of the respective cryptographic signatures 314A-N(shown in FIG. 3) stored on the blockchain. To accomplish this authentication, it must be proved that each frame of a video purporting to be video 302 (shown in FIG. 3) is signed with the same sequential cryptographic signature that matches the sequence of cryptographic signatures 314A-N stored in the blockchain.

FIG. 4 more specifically shows altered video 402, which is an altered version of cryptographically signed video 302, playing on a device 430. Disingenuous information has been added to altered video 402 to make it appear that original video 302 was recorded three months earlier than video 302 truly was recorded. Examples of disingenuous information can include inserting, overlaying, or otherwise editing digitally altered contextual identifier 410 in altered video 402 to aid this deception. In the example shown in FIG. 4, digitally altered contextual identifier 410 is a houseplant, the appearance of which changes with the season. This houseplant has been altered to appear as though it is only coming out of winter hibernation, with little to no foliage. Additional examples of disingenuous information can include inserting, overlaying, or otherwise editing digitally altered television program 408 in altered video 402 to aid this deception. In the example shown in FIG. 4, digitally altered television program 408 is a weather report from three months prior. Display screen of television 406 has been overlaid with the misleading broadcast. Furthermore, altered video 402 has been truncated to a forty-five (45) second runtime, instead of the one (1) minute runtime of original video 302.

Due to these alterations to several frames 404A-N(herein each individually, frame 404N) of altered video 402, several of the cryptographic signatures 414A-N (individually 414N) no longer match cryptographic signatures 314A-N. As such, when system 190 attempts to authenticate altered video 402 against the stored blockchain of cryptographically signed frames 304A-N and/or cryptographic signatures 314A-N for video 302, discontinuities become apparent. Furthermore, system 190 can decrypt cryptographic signatures 314A-N stored in the blockchain for any frames 304A-N having a context identifier 310. If an unencrypted cryptographic signature 314N reveals a date, time, or other status information that contradicts content of a corresponding frame 404N, then system 190 can determine that altered video 402 has been tampered with. Moreover, a checksum of the frames in altered video 402 will come up short compared with a checksum of the frames in cryptographically signed video 302, revealing that at least some frames have been removed. By contrast, if each sequential cryptographic signature of each frame that purports to be video 302 matches the sequence of cryptographic signatures 314A-N stored in the blockchain, then the purported video 302 can be authenticated as a true and accurate video 302.

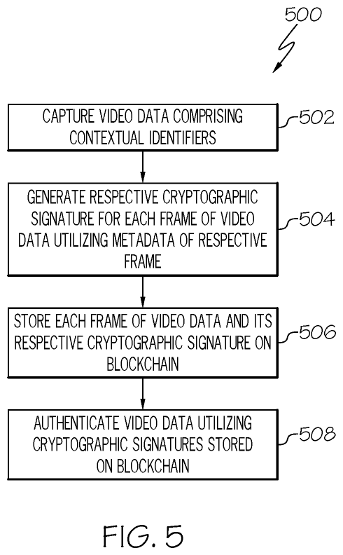

As depicted in FIG. 5, in one embodiment, a system (e.g., system 190 shown in FIG. 1) carries out the methodologies disclosed herein. Shown is a process flowchart 500 for authenticating video data utilizing contextual identifier. At 502, a set of video data comprising one or more contextual identifiers 310 (shown in FIG. 3) is captured. At 504, a respective cryptographic signature 314A-N(shown in FIG. 3) is generated for each frame 304 A-N(shown in FIG. 3) of the set of video data, wherein the respective cryptographic signature 314 A-N is generated utilizing metadata of respective the frame 304 A-N. At 506, each frame 304N of the set of video data and the respective cryptographic signature 314 A-N is stored on a blockchain. At 508, the set of video data is authenticated utilizing one or more of the respective cryptographic signatures 314 A-N stored on the blockchain.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for authenticating video data utilizing a contextual identifier, comprising:
capturing, by a processor, a set of video data comprising one or more contextual identifiers;
generating, by a processor, a respective cryptographic signature for each frame of the set of video data, wherein the respective cryptographic signature is generated utilizing metadata of the respective frame;
storing, by a processor, each frame of the set of video data and the respective cryptographic signature on a blockchain; and
authenticating, by a processor, the set of video data utilizing one or more of the respective cryptographic signatures stored on the blockchain.

2. The method of claim 1, further comprising identifying the one or more contextual identifiers in the set of video data; and
determining a date stamp utilizing the one or more contextual identifiers.

3. The method of claim 2, further comprising activating the one or more contextual identifiers using an Internet Protocol (IP) network.

4. The method of claim 3, wherein the one or more contextual identifiers comprise at least one of the following: an Internet of Things (IoT) network-connected appliance, a network-connected smart television, and a network-connected computing device.

5. The method of claim 1, wherein the metadata of the respective frame comprises at least one of the following: a check-sum of the respective frame, a date stamp of the contextual identifier, and Global Positioning System (GPS) data.

6. The method of claim 5, wherein the capturing a set of video data utilizes a network-connected smart camera, and wherein the metadata of the respective frame further comprises a unique serial number of the camera.

7. The method of claim 1, wherein the generating a respective cryptographic signature for each frame of the set of video data utilizes a cryptography integrated circuit operating in a secure enclave.

8. A computing system for authenticating video data utilizing a contextual identifier, comprising:
a processor;
a memory device coupled to the processor; and
a computer readable storage device coupled to the processor, wherein the storage device contains program code executable by the processor via the memory device to implement a method, the method comprising:
capturing, by the processor, a set of video data comprising one or more contextual identifiers;
generating, by the processor, a respective cryptographic signature for each frame of the set of video data, wherein the respective cryptographic signature is generated utilizing metadata of the respective frame;
storing, by the processor, each frame of the set of video data and the respective cryptographic signature on a blockchain; and
authenticating, by the processor, the set of video data utilizing one or more of the respective cryptographic signatures stored on the blockchain.

9. The computing system of claim 8, further comprising identifying, by the processor, the one or more contextual identifiers in the set of video data; and
determining, by the processor, a date stamp utilizing the one or more contextual identifiers.

10. The computing system of claim 9, further comprising activating, by the processor, the one or more contextual identifiers using an Internet Protocol (IP) network.

11. The computing system of claim 10, wherein the one or more contextual identifiers comprise at least one of the following: an Internet of Things (IoT) network-connected appliance, a network-connected smart television, and a network-connected computing device.

12. The computing system of claim 8, wherein the metadata of the respective frame comprises at least one of the following: a check-sum of the respective frame, a date stamp of the contextual identifier, and Global Positioning System (GPS) data.

13. The computing system of claim 12, wherein the capturing a set of video data utilizes a network-connected smart camera, and wherein the metadata of the respective frame further comprises a unique serial number of the camera.

14. The computing system of claim 8, wherein the generating a respective cryptographic signature for each frame of the set of video data utilizes a cryptography integrated circuit operating in a secure enclave.

15. A computer program product for authenticating video data utilizing a contextual identifier, the computer program product comprising a computer readable storage device, and program instructions stored on the computer readable storage device, to:
capture a set of video data comprising one or more contextual identifiers;
generate a respective cryptographic signature for each frame of the set of video data, wherein the respective cryptographic signature is generated utilizing metadata of the respective frame;
store each frame of the set of video data and the respective cryptographic signature on a blockchain; and
authenticate the set of video data utilizing one or more of the respective cryptographic signatures stored on the blockchain.

16. The computer program product of claim 15, further comprising program instructions stored on the computer readable storage device to identify the one or more contextual identifiers in the set of video data; and
determine a date stamp utilizing the one or more contextual identifiers.

17. The computer program product of claim 16, further comprising program instructions stored on the computer readable storage device to activating the one or more contextual identifiers using an Internet Protocol (IP) network, wherein the one or more contextual identifiers comprise at least one of the following: an Internet of Things (IoT) network-connected appliance, a network-connected smart television, and a network-connected computing device.

18. The computer program product of claim 15, wherein the metadata of the respective frame comprises at least one of the following: a check-sum of the respective frame, a date stamp of the contextual identifier, and Global Positioning System (GPS) data.

19. The computer program product of claim 18, wherein the capturing a set of video data utilizes a network-connected smart camera, and wherein the metadata of the respective frame further comprises a unique serial number of the camera.

20. The computer program product of claim 15, wherein the generating a respective cryptographic signature for each frame of the set of video data utilizes a cryptography integrated circuit operating in a secure enclave.
